(19) United States
(12) Patent Application Publication
(10) Pub. No.: US 2006/0134495 A1
(43) Pub. Date: Jun. 22, 2006

(54) Fuel cell system with cathode stream recirculation

(76) Inventors: Emerson R. Gallagher, Vancouver (CA); Russell H. Barton, New Westminster (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/016,341

(22) Filed: Dec. 17, 2004

(51) Int. Cl. H01M 8/04; F16L 55/02

(52) U.S. Cl. 429/34; 429/25; 251/118

(57) ABSTRACT

A fuel cell cathode recirculation valve is provided. The valve is configured to recirculate nearly 100% of a cathode outlet stream at idle and to exhaust all of a cathode outlet stream when the fuel cell is operating a full power.

### BACKGROUND OF THE INVENTION

1. Field of the Invention

The present invention generally relates to fuel cell systems with recirculation of a cathode stream and to valves for effecting such recirculation.

2. Description of the Related Art

Electrochemical fuel cell assemblies convert reactants, namely fuel and oxidant, to generate electric power and reaction products. Electrochemical fuel cell assemblies generally employ an electrolyte disposed between two electrodes, namely a cathode and an anode. The electrodes generally each comprise a porous, electrically conductive sheet material and an electrocatalyst disposed at the interface between the electrolyte and the electrode layers to induce the desired electrochemical reactions. The location of the electrocatalyst generally defines the electrochemically active area.

Solid polymer fuel cell assemblies typically employ a membrane electrode assembly (“MEA”) consisting of a solid polymer electrolyte, or ion exchange membrane, disposed between two electrode layers. The membrane, in addition to being an ion conductive (typically proton conductive) material, also acts as a barrier for isolating the reactant (i.e., fuel and oxidant) streams from each other.

The MEA is typically interposed between two separator plates, which are substantially impermeable to the reactant fluid streams, to form a fuel cell assembly. The plates act as current collectors, provide support for the adjacent electrodes, and typically contain flow field channels for supplying reactants to the MEA or for circulating coolant. The plates are typically known as flow field plates. The fuel cell assembly is typically compressed to ensure good electrical contact between the plates and the electrodes, as well as good sealing between fuel cell components. A plurality of fuel cell assemblies may be combined electrically, in series or in parallel, to form a fuel cell stack. In a fuel cell stack, a plate may be shared between two adjacent fuel cell assemblies, in which case the plate also separates the fluid streams of the two adjacent fuel cell assemblies. Such plates are commonly referred to as bipolar plates and may have flow channels for directing fuel and oxidant, or a reactant and coolant, on each major surface, respectively.

The fuel stream that is supplied to the anode typically comprises hydrogen. For example, the fuel stream may be a gas such as substantially pure hydrogen or a reformate stream containing hydrogen. The oxidant stream, which is supplied to the cathode, typically comprises a dilute oxygen stream such as air.

Each of the fuel cells making up a stack is typically flooded with air at a desired pressure, the desired pressure varying according to load demand. Furthermore, a minimum pressure differential must be maintained across the stack to prevent flooding. At low power operation however, this results in more oxygen than necessary being supplied to the stack, which has a consequential negative impact on the lifespan of the stack. The larger than required air flow also results in a larger than required humidity exchange requirement. This is of concern given that, at low power operation, low pressure automotive fuel cell systems are prone to drying out.

There is therefore a need for a fuel cell system that can operate efficiently over the whole range of a fuel cell stack's operating conditions and that addresses some of the above-mentioned concerns. The present invention addresses these and other needs, and provides further related advantages.

### BRIEF SUMMARY OF THE INVENTION

The invention provides a fuel cell cathode recirculation valve. In an embodiment of the invention, the recirculation valve comprises an inlet, a first and second outlet, a chamber, and a flow guide. Pursuant to the embodiment, the flow guide is configured to direct a fluid stream from the inlet to the first and/or second outlet. Pursuant to the embodiment, the flow guide is also operationally linked to the chamber's pressure.

In another embodiment of the invention, he recirculation valve further comprises a barrier, fluidly connected to the chamber, configured to move in response to changes in the chamber's pressure. Pursuant to the embodiment, the flow guide's movement is coupled to the barrier's movement.

In another embodiment of the invention, the recirculation valve further comprises a force transfer member, connecting the barrier and the flow guide. The force transfer member transmits on the flow guide a force directed away from the chamber. Pursuant to the embodiment, the recirculation valve further comprises a bias mechanism exerting on the flow guide a force directed towards the chamber. Pursuant to the embodiment, the flow guide moves inside a passage fluidly connecting the inlet to the first and second outlets.

Pursuant to the embodiment, the flow guide may comprise an inner hollow core and orifices, radially extending outward, fluidly connecting the inlet to the first and second outlets. Pursuant to the embodiment, the bias mechanism may comprise springs of differing stiffness. Pursuant to the embodiment, the barrier may be a diaphragm and the force transfer member may comprise a diaphragm support plate and a stem.

The invention also provides a fuel cell system where the air exhaust stream is recirculated during idle or low power operation.

In an embodiment of the invention, the fuel cell system comprises the cathode recirculation valve disclosed above, with the inlet being fluidly connected to the cathode outlet stream, the first outlet being fluidly connected to the cathode inlet stream and thus recirculating the cathode outlet stream, the second outlet being fluidly connected to the fuel cell system exhaust and the chamber being fluidly connected to the cathode inlet stream.

Specific details of certain embodiment(s) of the present apparatus/method are set forth in the detailed description below and illustrated in the enclosed Figures to provide an understanding of such embodiment(s). Persons skilled in the technology involved here will understand, however, that the present apparatus/method has additional embodiments, and/or may be practiced without at least some of the details set forth in the following description of preferred embodiment(s).

### BRIEF DESCRIPTION OF THE DRAWINGS

FIG. 1 is a side sectional view of a recirculation valve pursuant to the invention.

FIG. 2 is a schematic diagram of a fuel cell system, with a cathode recirculation valve, pursuant to the invention.

### DETAILED DESCRIPTION OF THE INVENTION

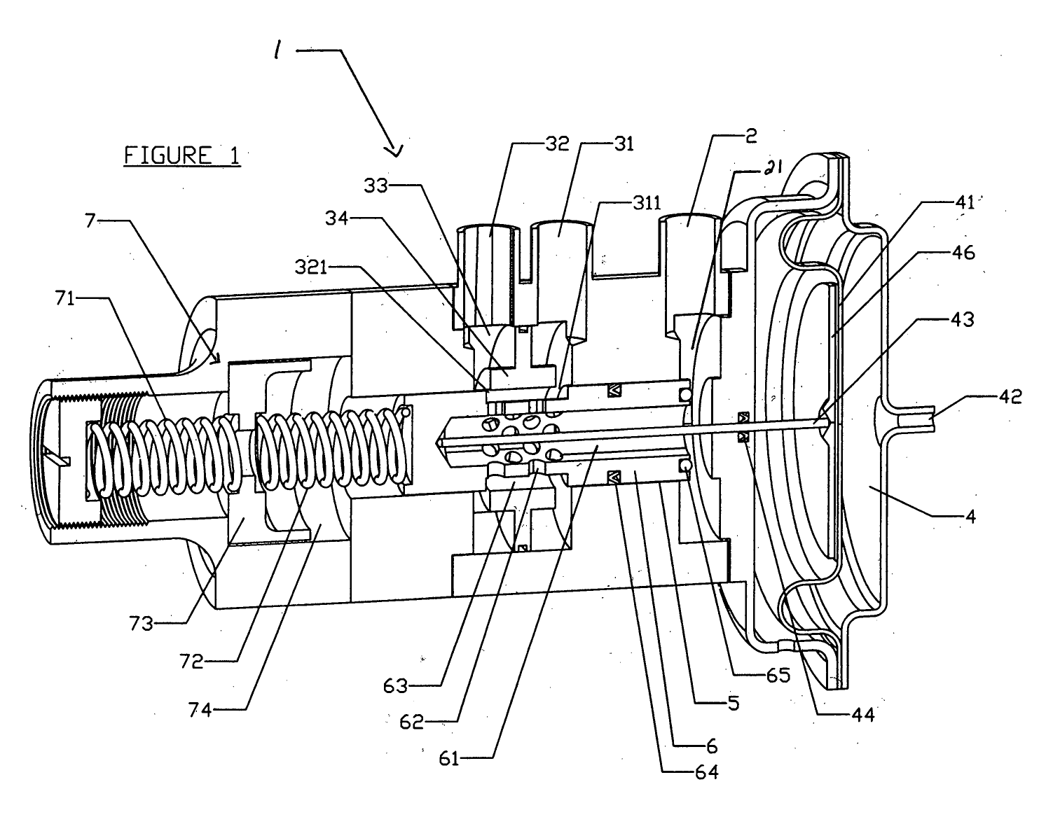

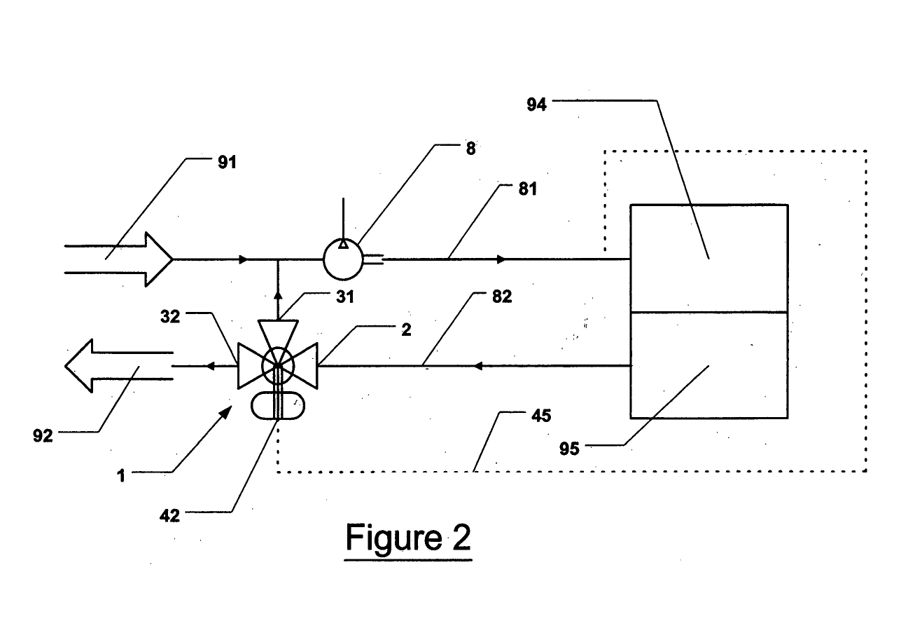

Many specific details of certain embodiments of the invention are set forth in the detailed description below, and illustrated in enclosed FIGS. 1 and 2, to provide a thorough understanding of such embodiments. One skilled in the art, however, will understand that the present invention may have additional embodiments, or may be practiced without several of the details described.

Each reactant stream exiting the fuel cell stack generally contains useful reactant products, such as water and unconsumed fuel or oxygen, which can be used by the fuel cell system through recirculation. Recirculating the air exhaust stream during low power operation results in the oxygen concentration in the cathode inlet stream to drop to a reduced level which, as referred to above, would have a beneficial effect on the lifetime of the stack. Because of the water contained in the air exhaust stream, its recirculation also reduces the humidity exchange requirement, which has a beneficial effect on the stack system's water balance. As the power requirement increases, a lesser amount of cathode exhaust air is being recirculated until the proper oxygen concentration and humidity level can be efficiently obtained solely from the inlet air stream and the cathode outlet stream is completely vented to the atmosphere.

In order to achieve the above-mentioned variable amount of cathode outlet stream recirculation, a recirculation valve is provided. An embodiment of a recirculation valve pursuant to the invention is shown at FIG. 1. Recirculation valve 1 includes an inlet 2 and a first outlet 31 and a second outlet 32. Inlet 2 is fluidly connected to first 31 and second 32 outlets via a cylindrical passageway 5. A flow guide 6 has a cylindrical inner core 61 and an outer annular groove 63. Inner core 61 and outer groove 63 are fluidly connected via orifices 62 radially extending outward. An annular channel 33 fluidly connects first 31 and second 32 inlets to annular groove 63. An annular plug 34 divides annular channel 33 and, as explained in more details below, directs flow from inner core 61 to first outlet 31 and/or second outlet 32.

It is understood that the shape of passageway 5, flow guide 6, inner core 61, outer groove 63, channel 33 and plug 34, are dictated by ease of manufacturing in the current embodiment and can therefore be shaped differently pursuant to the invention.

Flow guide 6 moves slideably within cylindrical passageway 5. A flow guide seal 64 facilitates the sealing and alignment of flow guide 6. Groove 63 and plug 34 are shaped with respect to one another so that, depending on the position of flow guide 6, there is fluid connection:

a) between inner core 61 and only first outlet 31, or

b) between inner core 61 and both first 31 and second 32 outlets, or

c) between inner core 61 and only second outlet 32.

Referring to FIG. 1, flow guide 6 is in a position that allows fluid connection between inner core 61 and both first 31 and second 32 outlets. This is because the face of annular plug 34 facing annular groove 63 has a smaller width, thereby allowing fluid to flow around both edges and into both first 31 and second 32 outlets, more specifically through first space 311 and second space 321. As flow guide 6 moves in either direction inside passageway 5, first space 311 becomes wider/narrower and second space 321 becomes narrower/wider until either of first 311 or second 321 space is closed and all flow is directed to either second 32 or first 31 outlet.

The movement of flow guide 6 is controlled as follows. Recirculation valve 1 includes a chamber 4. Recirculation valve 1 also includes a barrier 41, configured to move in response to changes in fluid pressure in chamber 4, and a chamber inlet port 42. In the current embodiment of the invention, barrier 41 is a diaphragm. When fluid pressure in chamber 4 increases, barrier 41 pushes against flow guide 6 via a force transfer member. In the current embodiment of the invention, the force transfer member comprises a metal diaphragm support plate 46 and a stem 43. Stem 43 is slender, so as to interfere as little as possible with a fluid flowing within inner core 61. When fluid pressure in chamber 4 increases, barrier 41 pushes against stem 43 which, in turn, pushes against the end of inner core 61 thereby pushing against low guide 6. A stem seal 44 facilitates the sealing and alignment of stem 43.

In pushing against flow guide 6, barrier 41 works against a bias mechanism 7 which provides an increasing response force, thereby ensuring a location of flow guide 6 within cylindrical passageway 5 which is coupled to the fluid pressure in chamber 4. In the current embodiment, bias mechanism 7 includes a first spring coil 71 and a second spring coil 72, wherein the spring stiffness of second spring coil 72 is greater than the spring stiffness of first spring coil 71. Bias mechanism 7 further includes a stop 73, moving slideably within a cavity 74 inside recirculation valve 1. Before stop 73 reaches the edge of cavity 74, movement of flow guide 6 results in a response force coming from the series configuration of first spring coil 71 and second spring coil 72. When stop 73 reaches the edge of cavity 74, any further movement of flow guide 6 results in a response force coming only from second spring coil 72. Consequently, a non-linear response force is achieved. It is understood that different bias mechanisms are possible pursuant to the invention, depending on whether a linear on non-linear response is necessary and what level of complexity in such response is desired. For example, in cases where a simple linear response is desired, a single spring coil could be all that is necessary. In another example, in cases where a complex non-linear response is desired, a number of springs, set in series and parallel configurations, and a number of stops could be present.

A check-valve O-ring 65 facilitates the sealing of inner core 61 from inlet 2 when flow guide 6 abuts against the edge of inlet 2's inner chamber 21.

When used in the context of a fuel cell system, recirculation valve 1 is connected and operated as shown in FIG. 2 pursuant to an embodiment of the invention. For the purpose of this disclosure, only the fuel cell system's cathode stream is schematically represented, more specifically only the fuel cell stack cathode's in 94 and out 95 segments. Chamber inlet port 42 is connected to a cathode inlet stream reference line 45, so that the pressure in chamber 4 is that of a cathode inlet stream 81. The fuel cell system's cathode outlet stream 82 is directed to inlet 2. First outlet 31 is connected to cathode inlet stream 81, preferably to the inlet of a cathode inlet compressor 8. As a result, cathode outlet stream 82 merges with the fuel cell system's cathode fresh supply stream 91 and is therefore recycled. Second outlet 32 is connected to the fuel cell system's cathode exhaust 92. When the fuel cell system is operating at idle, flow guide 6 is positioned within passageway 5 such that there is fluid connection primarily between inner core 61 and first outlet 31 (first space 311 is open and second space 321 is almost closed). Therefore, at idle, nearly 100% of cathode outlet stream 82 is recirculated (it flows from inlet 2 to inner core 61 through orifices 62 to outer groove 63 through first space 311 and out of first outlet 31). As the fuel cell system's power requirement increase, so does the pressure of cathode inlet stream 81. Consequently, the increased pressure in chamber 4 results in movement of flow guide 6, with the gradual closing of first space 311 and the gradual opening of second space 321. Therefore, as the fuel cell system's power requirement increases, the proportion of cathode outlet stream 82 that is recirculated decreases, until all of cathode outlet stream 82 is exhausted. Conversely, as the fuel cell system's power requirement decrease, the proportion of cathode outlet stream 82 that is recirculated increases, until all of cathode outlet stream 82 is recirculated. Furthermore (with reference to FIG. 1), at off-system conditions, bias mechanism 7 pushes flow guide 6 until it abuts against the edge of inner chamber 82; as a result, check-valve O-ring 65 seals inlet 2 from first 31 and second 32 outlets to prevent air backflow to the stack.

From the foregoing it will be appreciated that, although specific embodiments of the invention have been described herein for purposes of illustration, various modifications may be made without deviating from the spirit and scope of the invention. For example, flow guide 6 may be positioned such that, at idle, less than 100% of cathode outlet stream 82 is recirculated (e.g., 95%). In another example, groove 63 and plug 34 may be shaped so that, when flow guide 6 moves away from idle position, first space 311 does not immediately begin to close and/or second space 321 does not immediately begin to open, such closure/opening occurring after flow guide 6 has moved further. Accordingly, the invention is not limited except as by the appended claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A fuel cell cathode recirculation valve, comprising:
an inlet;
a first outlet;
a second outlet;
a chamber; and
a flow guide, configured to direct a fluid stream from the inlet to:
the first outlet, or
the second outlet, or
a combination of both outlets;
wherein the flow guide is operationally linked to the chamber's pressure.

2. The recirculation valve of claim 1, further comprising a barrier, fluidly connected to the chamber, configured to move in response to changes in the chamber's pressure, wherein the flow guide's movement is coupled to the barrier's movement.

3. The recirculation valve of claim 2, further comprising:
a force transfer member, connecting the barrier and the flow guide, transmitting on the flow guide a force directed away from the chamber;
a bias mechanism exerting on the flow guide a force directed towards the chamber;
wherein the flow guide moves inside a passage fluidly connecting the inlet to the first and second outlets

4. The recirculation valve of claim 3, wherein the flow guide comprises:
an inner hollow core, and
orifices, radially extending outward, fluidly connecting the inlet to the first and second outlets.

5. The recirculation valve of claim 3, wherein the bias mechanism comprises springs of differing stiffness.

6. The recirculation valve of claim 3, wherein the barrier is a diaphragm and wherein the force transfer member comprises a diaphragm support plate and a stem.

7. A fuel cell system comprising the cathode recirculation valve of claim 1, wherein:
the inlet is fluidly connected to a cathode outlet stream;
the first outlet is fluidly connected to a cathode inlet stream;
the second outlet is fluidly connected to an exhaust of the fuel cell system; and
the chamber is fluidly connected to the cathode inlet stream.
